(19) United States
(12) Patent Application Publication
(10) Pub. No.: US 2018/0146524 A1
(43) Pub. Date: May 24, 2018

(54) FLYBACK POWER SUPPLY FOR LED LAMPS

(71) Applicants: Wanjiong Lin, Ningbo (CN); Self Electronics Co., Ltd., Ningbo (CN); Self electronics USA Corporation, Norcross, GA (US)

(72) Inventors: Xuhong Ma, NINGBO (CN); Junjun Ying, NINGBO (CN); Zhiming Wang, NINGBO (CN)

(73) Assignees: Wanjiong Lin; Self Electronics Co., Ltd.; Self electronics USA Corporation

(21) Appl. No.: 15/819,955

(22) Filed: Nov. 21, 2017

(30) Foreign Application Priority Data
Nov. 23, 2016 (CN) 201611047502.5

(51) Int. Cl. H05B 33/08; H02M 3/335

(52) U.S. Cl. CPC H05B 33/0815; H02M 3/33507

(57) ABSTRACT

A flyback power supply for LED lamps includes at least two transformers, a switch, and loads. Each of transformers includes a primary coil and a secondary coil. The primary coil includes a positive input and a negative input. The secondary coil includes a positive output and a negative output. The positive input of the primary coil of one of the at least two transformers is connected with the positive input of the primary coil of other transformers, and the negative output of the primary coil of one of the at least two transformers is connected with the negative output of the primary coil of other transformers. The positive output of the secondary coil of the transformers is connected to the loads, and the negative output is connected to the positive and negative outputs of the secondary coil of the other transformers in turn.

### RELATED APPLICATION

This application claims priority to Chinese Patent Application No. CN 201611047502.5, filed on Nov. 23, 2016.

### BACKGROUND

### 1. Technical Field

The present invention relates to the application power supply field of lamp lighting, with particular emphasis on a flyback power supply for LED lamps.

### 2. Description of the Related Art

In ordinary daily life, all kinds of lighting apparatus can be seen everywhere, such as fluorescent lamps, street lamps, table lamps, artistic lamps and so on. In the above-described lighting apparatus, the tungsten bulb is traditionally used as a light-emitting light source. In recent years, due to the ever-changing technology, light-emitting diode (LED) has been used as a light source. Moreover, in addition to lighting apparatus, for the general traffic signs, billboards, headlights etc., light-emitting diode (LED) has also been used as a light source. The light-emitting diode (LED) as a light source has the advantages of energy-saving and greater brightness. Therefore, it has been gradually common.

However, since LED lamp is a component of DC power, the public power need usually to be converted into direct current when public power is used for supplying power and the direct current may be constant voltage or constant current. In the prior art, a transformer is generally used as power components to convert the public power into constant current for LED lamps. The LED lamp power supply which uses transformers is often referred as a flyback power supply as the power supply has a feedback circuit. However, in the actual use, the dimension of the entire flyback power supply becomes too large in a certain direction due to the dimension of the transformer, such as length, width height, or the like. As a result, it is difficult to install it to a component and causes a negative impact to the user experience.

### BRIEF DESCRIPTION OF THE DRAWINGS

The drawings described herein are intended to promote a further understanding of the present invention, as follows:

FIG. 1 is one of circuit diagram of a flyback power supply for LED lamps according to the present invention.

FIG. 2 is another circuit diagram of a flyback power supply for LED lamps according to the present invention.

### DETAILED DESCRIPTION OF THE INVENTION

The present application is illustrated by way of the following detailed description based on of the accompanying drawings. It should be noted that illustration to the embodiment in this application is not intended to limit the invention.

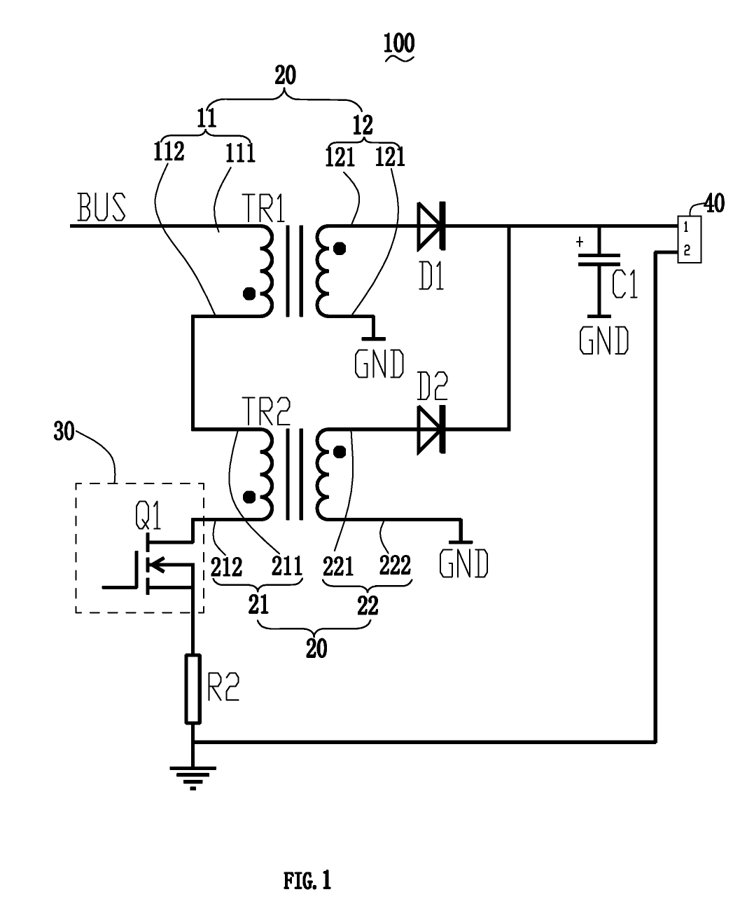

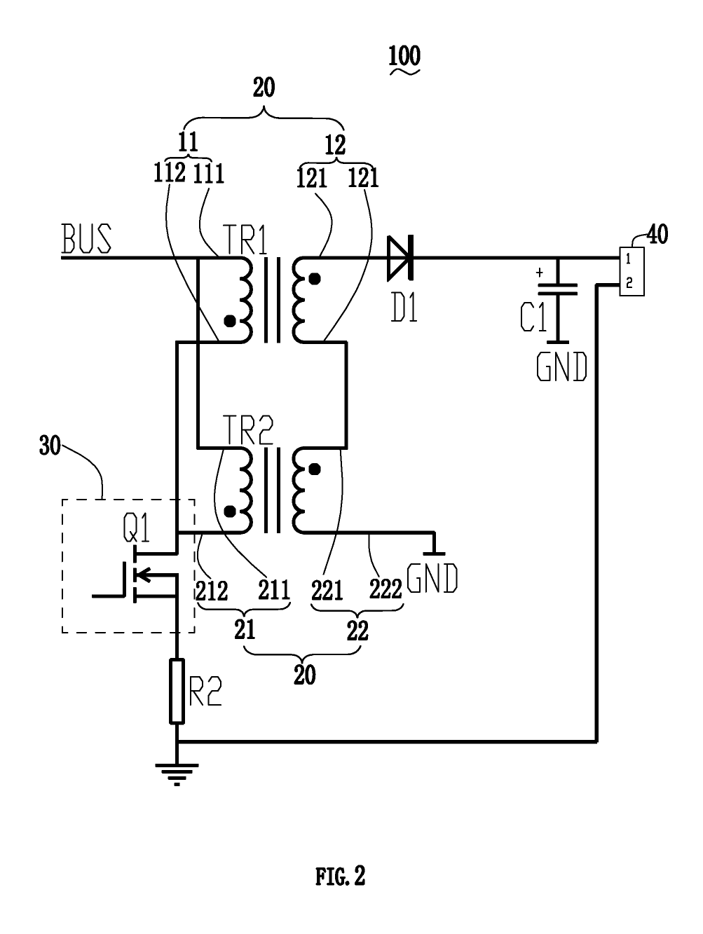

Referring to FIG. 1 to FIG. 2, two circuit diagrams of a flyback power supply 100 for LED lamps are provided according to the present invention. The flyback power supply 100 for LED lamps includes at least a first transformer 10 and at least a second transformer 20, a switch 30 for controlling one of the first and second transformers 10, 20, and loads 40 electrically connected to outputs of the first and second transformers 10, 20. It is understood that, as a power source for LED lamps, the flyback power supply 100 also certainly includes other functional modules, such as a rectifier filter circuit, a feedback control chip circuit, and so on, that are electrically connected to the inputs of the first and second transformers 10, 20, and a feedback circuit electrically connected to outputs of the first and second transformers 10, 20. However, the above functional module are well known to those skilled in the art and will not be described in detail here.

The flyback power supply 100 includes at least the first and second transformers 10, 20. That is to way, three or more transformers can be included. In the present invention, in order to solve the problem of dimensional, the flyback power supply 100 uses a plurality of transformers to perform conversion of output power. Moreover, it is possible to redesign a magnetic core and a skeleton of the transformer which can match with space requirement. In result, only one transformer can be used to complete the above output power transformation. However, in practice, the flyback power supply 100 has various output power. Therefore, it is impossible to design a new magnetic core and skeleton for each of output power as it not only causes a high cost and great waste, but also is not conducive to environmental protection. Therefore, it is an object of the present invention to take advantage of the current magnetic core and a skeleton, and a plurality of transformers made of the current magnetic core and the skeleton to achieve the above-mentioned output power conversion. As a result, it can solve the problem of dimensional limitation and reduce waste and protect the environment. In the present embodiment, the flyback power supply 100 only includes the first and second transformers 10, 20 to illustrate the present invention as an example.

The first and second transformers 10, 20 have the same dimension, structure and parameters of magnetic core and skeleton, primary and secondary coil turn number, wire diameter, and so on. It is well known to those skilled in the art that each of the first and second transformers 10, 20 includes a primary coil, a secondary coil coupled to the primary coil, a positive input and a negative input arranged on the primary coil, and a positive output and a negative outputs arranged on the secondary coil. However, in order to explain the present invention, the first and second transformers 10, 20 need to be described in detail. The first transformer 10 includes a first primary coil 11 and a first secondary coil 12. The first primary coil 11 includes a first positive input 111 and a first negative input 112. The first secondary coil 12 includes a first positive output 121 and a first negative output 122. The second transformer 20 includes a second primary coil 21 and a second secondary coil 22. The second primary coil 21 includes a first positive input 211 and a second negative input 212. The second secondary coil 22 includes a first positive output 221 and a second negative output 222.

The first and second transformers 10, 20 may have two kinds of connection methods to achieve the above purpose according to requirement of output power conversion. The first method is that the first positive input 111 of the first primary coil 11 of the first transformer 10 is the power supply input and is electrically connected to the second positive input 211 of the second primary coil 21, and the first negative input 112 of the first primary coil 11 is electrically connected to the second negative input 212 of the second primary coil 22 and is electrically connected to the switch 13. The first positive output 121 of the first secondary coil 11 of the first transformer 10 is electrically connected to the load 14, and the second negative output 122 of the first secondary coil 11 is electrically connected to the second positive output 221 of the second primary coil 22. Based on the first connection method, when there are pluralities of the transformers, all of the positive inputs of the primary coil of the plurality of transformers are connected together, and the negative inputs of the primary coil are connected together. The positive output of the secondary coil of the plurality of transformers is connected to the load, the negative output of the secondary coil is connected to the positive output of the secondary coil of another transformer, and the negative output of another transformer is connected to a positive output of the secondary coil of the third transformer, and so on. That is to say, the positive and negative outputs of the secondary coil are connected in turn, and the last negative output of the transformer is connected to the switch 13.

In the first method shown in FIG. 1, when the first positive output 121 of the first secondary coil 12 of the first transformer 10 is electrically connected to the load 14, a diode D1 is connected between the first positive output 121 and the load 14. Specifically, the positive electrode of the diode D1 is connected to the first positive output 121, and the negative electrode thereof is connected to the load 14.

In addition, if the dimension is not limited in the first method, it is also possible to use only one single transformer instead of the first and second transformers 10, 20. Compared to the first and second transformers 10, 20, the single transformer has the same output parameters, such as output power. Compared to the single transformer, the peak current of each of the first and second transformers 10, 20 is same as that of the single transformer, and the discharge current of each of the first and second transformers 10, 20 is same as that of the single transformer. Coil number of the primary coil of each of the first and second transformers 10, 20 is one half of that of the primary coil of the single transformer, and the diameter of coil of the first and second transformers 10, 20 and the single transformer is same. Coil number of the secondary coil of each of transformer is same as that of the secondary coil of the single transformer, and the diameter of coil of the secondary coil can be reduced.

Next, a second connection method of the first and second transformers 10,20 will be described in detail. As shown in FIG. 2, the first positive input 111 of the primary coil 11, 21 of the first and second transformers 10, 20 is power input terminal, and the first negative input 112 is connected to the second positive input 221. The second negative input 212 is electrically connected to the switch 13. The first and second positive output terminals 121, 221 of all of the secondary coil 12, 22 are connected to the load 14, and the first and second negative output 122, 222 are grounded. Based on the second connection method, when the flyback power supply 100 includes a plurality of the first and second transformers 10, 20, the first positive input 111 of the first primary coil 11 of the first transformer 10 is the power input, and then the other positive and negative input are connected in turn. Finally, only one negative input is electrically connected to the switch 13. All of the positive outputs of the secondary coil of the plurality of first and second transformers 10, 20 are both connected to the load 14 and the negative outputs are all grounded.

In the second connection method, two diode D1 are respectively connected between the first positive output 121 of the first secondary coil 12 and the second positive output 221 of the second secondary coil 22 and the load 14. The positive electrodes of the two diodes D1 are respectively connected to the first and second positive output terminals 121, 221, and the negative electrode thereof is connected to the load 14.

In the second connection method, if the dimension is not limited, it is also possible to use only one single transformer instead of the first and second transformers 10, 20. The charging current of each of the first and second transformers 10, 20 is one half of that of the single transformer, and the discharge current of each of the first and second transformers 10, 20 is one half of that of the single transformer. Moreover, compared with the single transformer, coil number of the primary coil of each of the first and second transformers 10, 20 is same as that of the primary coil of the single transformer, and coile number of the secondary coil of each of the first and second transformers 10, 20 is one half of that of the secondary coil of the single transformer.

The switch 13 may be a MOS transistor, and a drain of the MOS transistor is connected to the negative input of the primary coil of the first and second transformers 10, 20. In the present embodiment, the drain of the MOS transistor is connected to the second negative input 222 of the second primary coil 22 of the second transformer 20. A source of the MOS transistor is grounded and a grid electrode is electrically connected to other functional modules, such as the feedback control chip circuit, to control the MOS transistor.

The load 14 may be LED lamps, which can include a plurality of LED chips connected in series or in parallel as prior art, will be not described in the present invention.

As described above, the flyback power supply 100 includes at least two of the first and the second transformer 10, 20 instead of the separate single transformer to reduce the dimension in one direction so that the current magnetic core and skeleton can be used. Moreover, the flyback power supply 100 can reduce the dimension of the entire product in a certain direction, and can be match with the user's installation requirements and increase the user experience.

The above disclosure has been described by way of example and in terms of exemplary embodiment, and it is to be understood that the disclosure is not limited thereto. Rather, any modifications, equivalent alternatives or improvement etc. within the spirit of the invention are encompassed within the scope of the invention as set forth in the appended claims.

What is claimed is:

1. A flyback power supply for LED lamps, comprising:
at least a first transformer and at least a second transformers,
a switch for controlling one of the first and second transformers, and
loads electrically connected to the output of the first and second transformers, the first transformer comprising a first primary coil and a first secondary coil coupling to the first primary coil, the second transformer comprising a second primary coil and a second secondary coil, the first primary coil comprising a first positive input and a first negative input, the first secondary coil comprising a first positive output and a first negative output, the second primary coil comprising a second positive input and a second negative input, the second secondary coil comprising a second positive output and a second negative output, the first positive input of the first primary coil of the first transformer being connected with the positive input of the second primary coil, the first negative output of the first primary coil being connected with the negative output of the second primary coil, the first positive output of the first secondary coil of the first transformer being connected to the loads, the first negative output of the first secondary coil being connected with the second positive output of the second secondary coil; or all of the first and second positive inputs and the first and second negative inputs of the first and second transformers being connected in turn, all of the first positive outputs of the first transformers and the second positive outputs of the second transformers being connected to the loads, and the first and second negative outputs are grounded, wherein, when the first positive input of the first primary coil is connected with the second positive input of the second primary coil, each of the negative output of the first and second primary coils are electrically connected to the switch, and when the first and second positive outputs and the first and second negative outputs of the first and second transformers are connected in turn, only one of the first and second negative outputs is electrically connected to the switch.

2. The flyback power supply for LED lamps as claimed in claim 1, wherein when all of the first and second positive output of the first and second secondary coil of the first and second transformers are electrically connected to the loads, and the first and second negative output is grounded, two diodes are respectively connected between the first and second positive output of the first and second secondary coil, a positive electrode of the diode is electrically connected to the first and second positive outputs and a negative electrode thereof is grounded.

3. The flyback power supply for LED lamps as claimed in claim 1, wherein when the first positive output of the first secondary coil is electrically connected to the loads, a diode is electrically connected between the first positive output and the loads, a positive electrode of the diode is electrically connected to the first positive output, and a negative electrode thereof is electrically connected to the loads.

4. The flyback power supply for LED lamps as claimed in claim 1, wherein the switch is a MOS transistor, and a drain of the MOS transistor is connected to the second negative input of the second primary coil.

5. The flyback power supply for LED lamps as claimed in claim 1, wherein parameters of each of at least the first and second transformers are the same.

6. The flyback power supply for LED lamps as claimed in claim 1, wherein when the first positive input of the first primary coil of the first transformer is connected with the second positive input of the second primary coil of the second transformer, the first negative output of the first primary coil of the first transformer is connected with the second negative output of the second primary coil of the second transformer, the first positive output of the first secondary coil of the first transformer is connected to the loads, and the first negative output of the first secondary coil is connected with the second positive output of the second secondary coil, compared with a single transformer with same output parameter, the peak current of the first and second transformers is same as that of the single transformer, and the discharge current of the first and second transformers is same as that of the single transformer.

7. The flyback power supply for LED lamps as claimed in claim 6, wherein coil number of the primary coil of the first and second transformers is one half of that of a primary coil of the single transformer respectively, and a diameter of coil of the primary coil is the same, coil number of the secondary coil of the first and second transformers is same as that of a secondary coil of the single transformer.

8. The flyback power supply for LED lamps as claimed in claim 1, wherein all of the positive and negative inputs of the primary coil of the first and second transformers are successively connected, and all of the positive outputs of the first and second secondary coils are connected to the loads and the negative outputs are grounded, compared with a single transformer with same output parameter, a charging current of the first and second transformers is one half of that of the single transformer, and the discharge current of the first and second transformers is one half of that of the single transformer.

9. The flyback power supply for LED lamps as claimed in claim 8, wherein coil number of the primary coil of the first and the second transformers is same as that of a primary coil of the single transformer, and coil number of the secondary coil of the first and the second transformers is one half of that of a secondary coil of the single transformer.
